(19) United States
(12) Patent Application Publication
(10) Pub. No.: US 2010/0231590 A1
(43) Pub. Date: Sep. 16, 2010

(54) CREATING AND MODIFYING 3D OBJECT TEXTURES

(75) Inventors: Gurel Erceis, Istanbul (TR); Engin Erenturk, Istanbul (TR)

Correspondence Address: PERKINS COIE LLP, P.O. BOX 1208, SEATTLE, WA, 98111-1208, US

(73) Assignee: Yogurt Bilgi Teknolojileri A.S., Istanbul (TR)

(21) Appl. No.: 12/721,526

(22) Filed: Mar. 10, 2010

Related U.S. Application Data
(60) Provisional application No. 61/159,043, filed on Mar. 10, 2009.
(60) Provisional application No. 61/167,015, filed on Apr. 6, 2009.

(51) Int. Cl. G06T 15/60; G06F 3/048

(52) U.S. Cl. 345/426; 715/852; 715/853

(57) ABSTRACT

A method and system for providing a graphical user interface to manipulate 3D object textures. The method includes retrieving a mesh object for editing, wherein the mesh object is associated with a mask layer, a detail layer, and a shadow layer. The method includes displaying a hierarchical tree of the layers associated with the mesh object, wherein each layer is associated with a drawing order, a color blending function, and a rule set. The method includes, responsive to receiving a first set of user commands via a GUI, adding or editing at least one layer associated with the mesh object. The method includes responsive to receiving a second set of user commands via the GUI, adding or editing at least one of: the drawing order, the color blending function, and the rule set associated with a layer. The method includes automatically rendering the 3D object for user preview.

### CROSS-REFERENCE TO RELATED APPLICATIONS

This application claims the benefit of U.S. Provisional Application No. 61/159,043 entitled “METHOD AND SYSTEM FOR CREATING AND MODIFYING TEXTURES OF 3D OBJECTS”, filed Mar. 10, 2009, and is hereby incorporated by reference in its entirety.

### BACKGROUND

Three-dimensional (3D) rendering is a computer graphics process for converting 3D objects into 2D images for display on a two-dimensional (2D) surface, such as a computer display. The three parts of a 3D object include a “mesh object,” a “skeleton,” and an animation description of the 3D object. A mesh object is a collection of vertices, edges, and faces defining the shape of a polyhedral object in 3D computer graphics. The mesh object usually consist of triangles, quadrilaterals, or other simple convex polygons, since this simplifies rendering; but may also be composed of more general concave polygons, or polygons with holes. FIG. 12 depicts an example of a 3D mesh object. 3D mesh objects can be stored at a server or database and transmitted to a user workstation on demand. A skeleton describes a 3D object for rendering and display in a 3D character animation that is correlated with a human skeleton. “Skinning” is the process of connecting a 3D object's mesh to its corresponding skeleton. This is done by attaching the 3D object's mesh to a set of bones in a skeletal animation. Finally, an animation description provides information about movements and changes of a 3D object over time. Rendering the 3D object produces a sequence of 2D images, which shows an animation of the 3D object when displayed sequentially.

A 3D object can be an “avatar” or other entity in a virtual environment. An avatar is a computer user's representation of himself or herself—e.g., an alter ego—whether in the form of a 3D model used in computer games, or a 2D icon, etc. A virtual world is a computer-based simulated environment intended for its users to inhabit and interact with other users via avatars. A user's workstation can access this computer-simulated virtual world. A virtual world includes various perceptual stimuli (e.g., visual graphics and audible sound effects) presented to users, who in turn, can manipulate elements in the virtual world. One type of virtual world includes “massively multiplayer online games” (MMOG) commonly depicting a world very similar to the real world, with real-world rules, real-time actions, and communication. Communications between users include text, graphic icons; and visual gestures and sounds. Although, communication is usually textual, with real-time voice communication using voice-over-IP (VoIP) also possible.

A user workstation can display many 3D objects, such as avatars, in a virtual world.

Unfortunately, workstation resources and available bandwidth can limit workstation performance. Current applications such as Adobe Flash Player allow rendering 3D data into animation sequences via Action Script code. The computer's volatile memory (RAM) generates the rendering for immediate display or later storage into non-volatile memory. Current approaches to distributing animation sequences include distributing a rendered sequence as an inseparable package. But this reduces display flexibility at the workstation. A 3D object consisting of a mesh object and skeleton can provide an outline of an avatar in a 3D virtual world, but frequently lacks other details such as clothing, shadows, facial features, etc. Such details can be provided with “textures,” which are layered on top of the 3D object when rendered. However, it is generally difficult to create and edit such textures.

### SUMMARY

Embodiments provide methods, apparatuses, and computer-readable media for creating and modifying textures of 3D objects including: retrieving a mask layer defining a color for a fill area; retrieving a detail layer defining 3D object details to be displayed; retrieving a shadow layer defining 3D object surface shadows; and merging these layers into a texture for rendering on the 3D object. In at least certain embodiments, each layer includes a plurality of rule sets defining its rendering properties. Color blending the layers may also be performed pursuant to a set of rules.

Other embodiments include a graphical user interface (GUI) configured to manipulate 3D object textures. The GUI retrieves mesh objects for editing, where each mesh object may be associated with a mask layer, detail layer, and shadow layer. The GUI may display a hierarchical tree of the layers associated with the mesh object, where each layer is associated with a drawing order, color blending function, and one or more rule sets. The GUI may be further configured to add or edit a layer associated with the mesh object responsive to receiving a first set of user command. And the GUI may be configured to add or edit the drawing order, color blending function, or rule set associated with the layer responsive to receiving a second set of user commands.

### BRIEF DESCRIPTION OF DRAWINGS

Embodiments of the present invention are described with reference to the following drawings. In the drawings, like reference numerals refer to like parts throughout the various figures unless otherwise specified. For a better understanding of at least certain embodiments, reference will be made to the following Detailed Description, which is to be read in conjunction with the accompanying drawings, wherein:

FIG. 1 depicts an example system for creating and modifying textures of 3D objects.

FIG. 2 depicts an example workstation for displaying 3D objects to a user.

FIG. 4A depicts a method for rendering a 3D object with textures according to an illustrative embodiment.

FIG. 4B depicts method for creating and modifying a 3D object with textures according to an illustrative embodiment.

FIG. 5A depicts a mask layer according to an illustrative embodiment.

FIG. 5B depicts a detail layer according to an illustrative embodiment.

FIG. 5C depicts a shadow layer according to an illustrative embodiment.

FIG. 6A depicts a first example of a merged result.

FIG. 6B depicts a second example of a merged result.

FIG. 6C depicts a third example of a merged result.

FIG. 7 depicts a hierarchical tree graphical user interface according to an illustrative embodiment.

FIG. 8A depicts an example face texture.

FIG. 8B depicts an example face texture with beard color.

FIG. 9A depicts a first example of final texture data.

FIG. 9B depicts a second example of final texture data.

FIG. 9C depicts a third example of final texture data.

FIG. 10 depicts a texture tool according to an illustrative embodiment.

FIG. 11A depicts a first example avatar with texture.

FIG. 11B depicts a second example avatar with texture.

FIG. 11C depicts a third example avatar with texture.

FIG. 12 depicts an example of a 3D mesh object.

### DETAILED DESCRIPTION

A graphical user interface (GUI) is provided for a designer to create and modify textures for a 3D object. The 3D object is defined by at least a mesh object coupled with a skeleton. The 3D object can also be animated using an animated description. A “texture” provides the surface details of the 3D object, and may be divided into a “mask layer,” “detail layer,” and “shadow layer.” By dividing the texture into these layers, the GUI can easily allow a designer to create and modify complex textures for improved user experience.

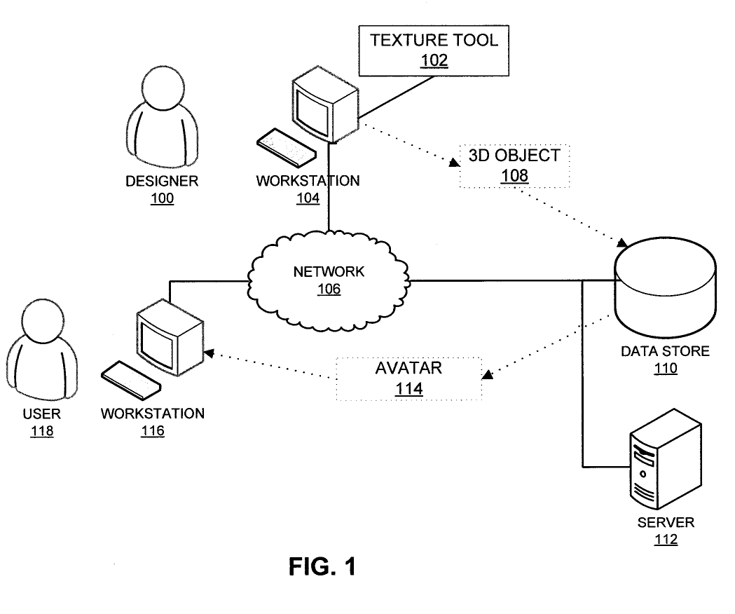

FIG. 1 illustrates an example system for creating and modifying textures of 3D objects. FIG. 1 includes workstations 104 and 116 coupled with server 112 and data store 110 over a network 106; and further includes texture tool 102. Texture tool 102 can be implemented in computer hardware including special-purpose circuitry, or general-purpose circuitry that is programmed with software or firmware; or any combination thereof. Texture tool 102 can execute on a workstation 102. Designers 100 can use the texture tool 102 to create one or more 3D objects 108. 3D object 108 may include a mesh object, skeleton, and animation description defining a sequence that can be rendered for playback. In one embodiment, the 3D object components are exported by the workstation 102 into two files: a first file containing the mesh object and skeleton data, and a second file containing the animation description data.

3D object 108 can be transmitted over a network 106 to a data store 110. Network 106 can be any network configured to transmit and forward digital data, and can be wired or wireless. Data store 110 can be a computer-readable medium that stores data such as a disk drive, or a system of disk drives such as a database. In the illustrated embodiment, data store 110 is configured to serve 3D object components responsive to requests received over network 106. Server 112 may interface between the network 106 and the data store 110. It will be appreciated that any number of servers can exist in the system and can be distributed geographically to improve performance and redundancy.

3D object 108 can represent an avatar 114 in a virtual world (not shown). In one embodiment, server 112 provides a virtual world to workstation 116 operated by user(s) 118. In this example, avatar 114 is created by user(s) 118 and can be stored at data store 110 or within workstation 116, or both. The avatar 114 can include textures defined by texture tool 102. The texture tool 102 can be used by designer 100 or user 118 to create texture data for the avatar 114. The texture data can define the surface details for display on top of avatar 114 within the virtual world provided by server 112.

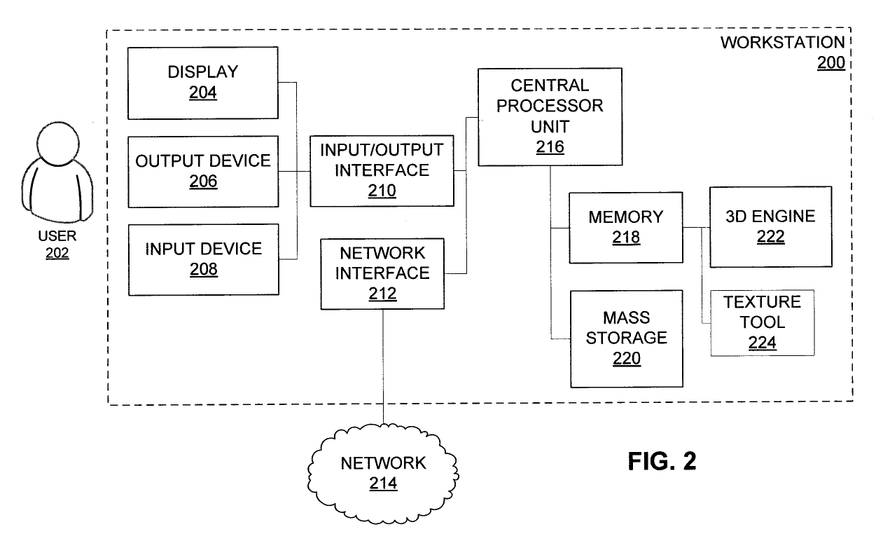

FIG. 2 depicts a workstation for rendering 3D objects according to an illustrative embodiment. In this embodiment, workstation 200 provides an interface to user(s) 202. Workstation 200 provides a computing platform for various applications and is accessible to the user 202. Workstation 200 can be configured to receive 3D object components from either a server or a data store over a network, or both. Workstation 200 can also be a server itself; or can be any other data processing device such as a server, a personal computer, desktop computer, laptop computer, a personal digital assistant (PDA), etc. Workstation 200 can include a display 204. Display 204 can be physical equipment that displays viewable images and text generated by the workstation 200, such as a cathode ray tube (CRT) or a flat panel display such as an LCD. Display 204 includes a display surface and circuitry to generate a picture from electronic signals sent by workstation 200. Display 204 interfaces with an input/output interface 210, which translates data from the workstation 200 to signals for display 204.

Workstation 200 may also include one or more output devices 206 and one or more input devices 208. Output device 206 is hardware used to communicate with the user, such as speakers or printers. Input device 208 is computer hardware used to translate inputs received from the user 202 into data for workstation 200. Input device 208 can be keyboards, mouse devices, microphones, scanners, video and digital cameras, etc. Workstation 200 also includes an input/output interface 210, which can include logic and physical ports used to connect and control peripheral devices, such as output devices 206 and input devices 208.

In the illustrated embodiment, workstation 200 includes a network interface 212. Network interface 212 contains logic and physical ports used to connect to one or more networks. Network interface 212 can accept a physical or wireless network connection between a network and workstation 200. Alternatively, workstation 200 can include multiple network interfaces for interfacing with multiple networks. Workstation 200 communicates with network 214 over the network interface 212. Network 214 can be any network configured to carry digital information. For example, network 214 can be an Ethernet network, the Internet, a wireless network, a cellular data network; or any Local Area Network or Wide Area Network.

Workstation 200 further includes a central processing unit (CPU) 216. CPU 216 can be a general-purpose processor, such as a microprocessor; or any other integrated circuit configured for a variety of computing applications. And CPU 216 can be implemented on a single-chip or multiple-chip substrates. Further, CPU 216 can be installed on a motherboard within the workstation 200 to control other workstation components. CPU 216 communicates with other workstation 200 components via an integrated circuit bus, or any other interconnect or communication channel. Workstation 200 further includes a memory 218, which can be volatile or non-volatile memory accessible to CPU 216. Memory 218 can be random access memory (RAM) to store data required by CPU 216 to execute installed applications. CPU 216 may additionally include an on-board cache memory for faster performance. Workstation 200 includes mass storage device 220, which can also be volatile or non-volatile memory configured to store large amounts of data. Mass storage device 220 is accessible to the CPU 216 over a communications channel such as an integrated circuit bus or other physical interconnect. Mass storage device 220 can be a hard drive, a RAID array, flash memory, CD-ROMs, DVDs, HD-DVD, etc.

Additionally, workstation 200 includes a 3D engine 222, which can be implemented in computer hardware including special-purpose circuitry coupled with memory 218, or can be implemented in general-purpose circuitry that is programmed with software or firmware, or combination, stored within memory 218; or any combination of hardware, software and firmware. 3D engine 222 is configured for rendering 3D objects in a 2D display as discussed above. 3D objects can be received as a polygon mesh object, a skeleton, and an animation description. 3D engine 222 can be configured to render a sequence for display from a 3D object. 3D engine 22 can run in a browser as a Flash application or a standalone as an AIR application. 3D engine 222 can be a Flash-based engine written in Action Script 3.0 requiring a Flash 10 player. 3D engine 22 can also be based on a SwiftGL 3D Flash graphics library. 3D engine 22 supports skeletal animation, as well as scene-based and model-based depth sorting.

Workstation 200 also includes texture tool 224, which can be implemented in computer hardware including special-purpose circuitry, or general-purpose circuitry programmed with software or firmware; or any combination thereof. As such, texture tool 224 can be coupled with memory 218, or can be software or firmware stored within memory 218, and executed by CPU 216. Texture tool 224 can include computer-readable instructions for providing texture functionality (see below).

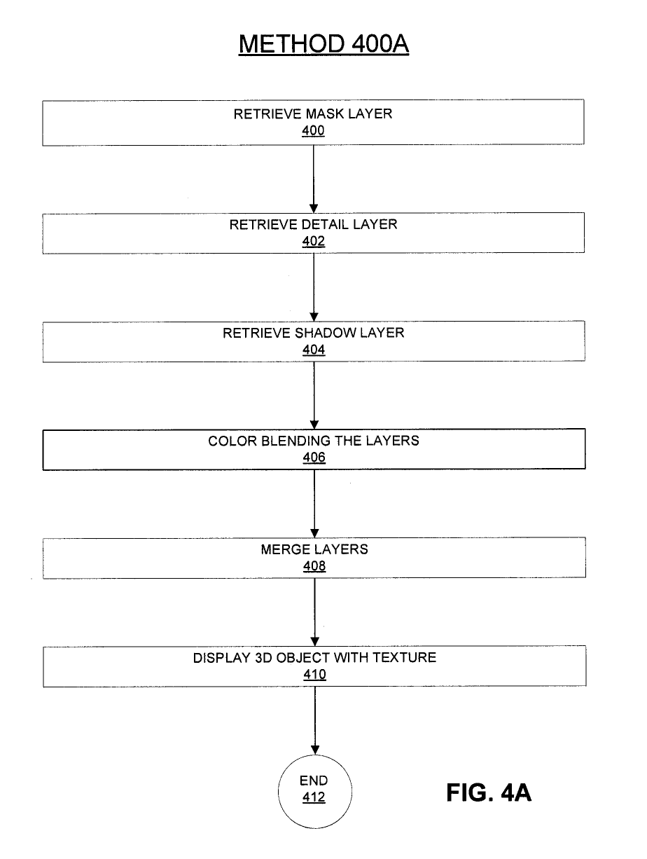

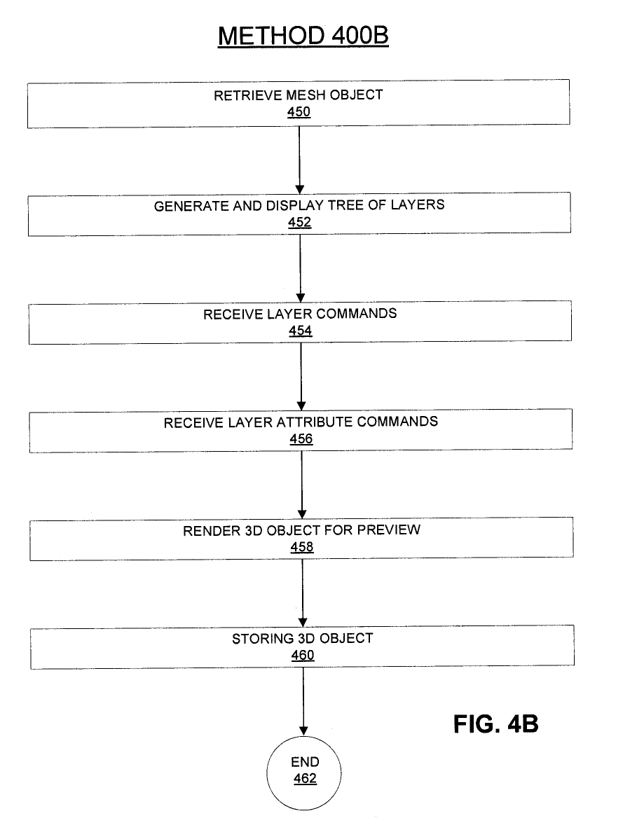

FIG. 4A depicts a method for rendering a 3D object with textures according to an illustrative embodiment. Method 400A can execute on a workstation, rendering and displaying 3D objects to user(s). Alternatively, method 400A can execute on a server to pre-process 3D objects with texture to reduce workstation loading—the workstation may receive 3D objects and associated components from the server. At operation 400, the workstation retrieves a mask layer as part of a 3D object. Each mask layer includes an image used to define a fill area to provide background color on a piece of clothing, for example. The workstation then retrieves a detail layer (operation 402), which can also be received as part of the 3D object. The detail layer is used to define details of, for example, a clothing item for an avatar. The workstation also retrieves a shadow layer (operation 404). The shadow layer can be received as part of a 3D object to define, e.g., shadows for more realistic avatar appearance. The shadow layer can also be transparent. 3D objects can have multiple mask layers, detail layers and shadow layers.

At operation 406, the workstation can (optionally) color blend the received layers. Color blending can be defined by a color blending function specified by a texture tool. This allows colors of different layers to be blended for a more realistic avatar appearance. The layers retrieved above are then merged at operation 408. In one embodiment, the layers can be merged by drawing them on top of each other—in order. The mask layer is drawn first; detail layer second; and shadow layer third. Once the merging is complete, the workstation displays the rendered 3D object with the texture (operation 410) and exits method 400A (operation 412).

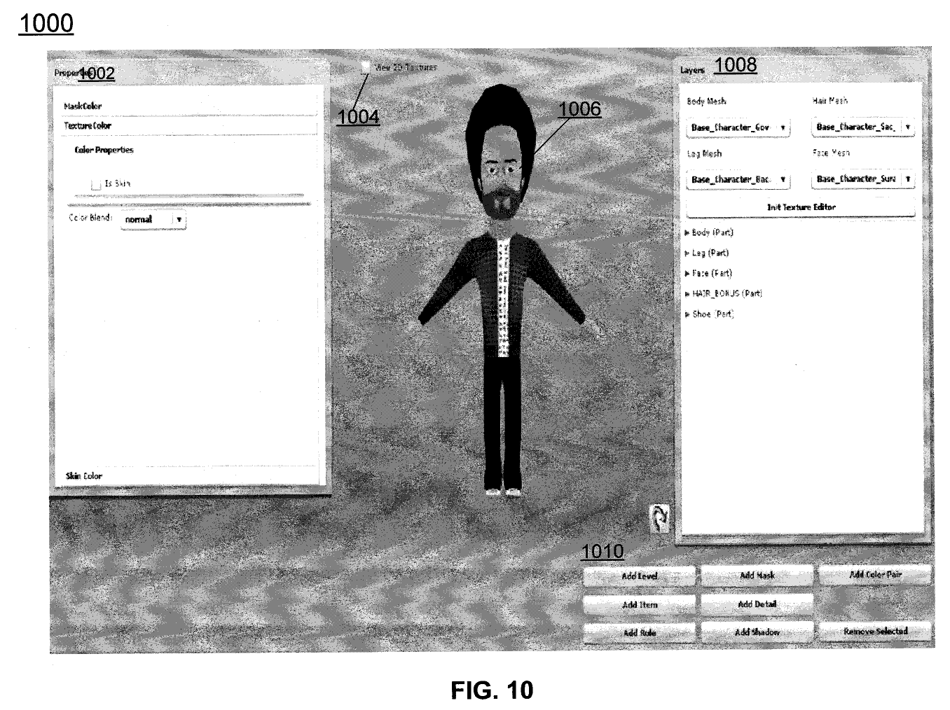

FIG. 4B illustrates a method for creating and modifying a 3D object with textures according to an illustrative embodiment. Method 400B can execute on a workstation (not shown) to provide a texture tool to a local user, or can execute on a server (not shown) to provide the texture tool to a remote user. At operation 450, the workstation retrieves the mesh object. The mesh object can be a component of the 3D object created above, and can be associated with a plurality of layers, such as a mask layer, detail layer, and shadow layer. In an alternative embodiment, the 3D object can be retrieved in its entirety. The workstation then generates and displays a tree of layers from the mesh object at operation 452. Each layer can be displayed as a node. Thereafter, the workstation receives layer commands (operation 454) and layer attribute commands (operation 456) from a user via the GUI. One illustrative embodiment of a GUI is depicted in FIG. 10. Users can create new layers or modify existing layers. Users may also create new layer attributes or modify existing layer attributes. The workstation then renders the 3D object with associated layer information (operation 458), and stores the layer information (operation 460) for user preview. At operation 462, the workstation exits method 400B.

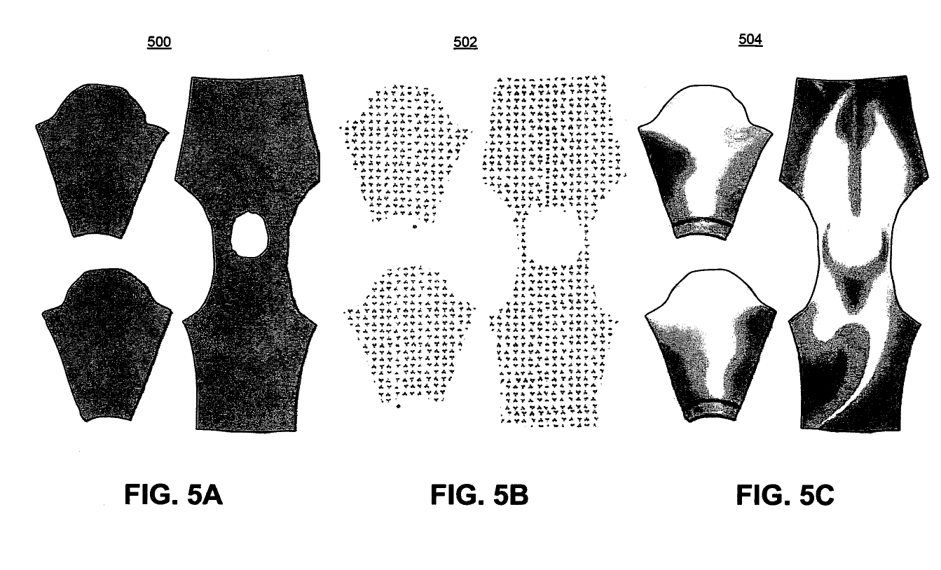

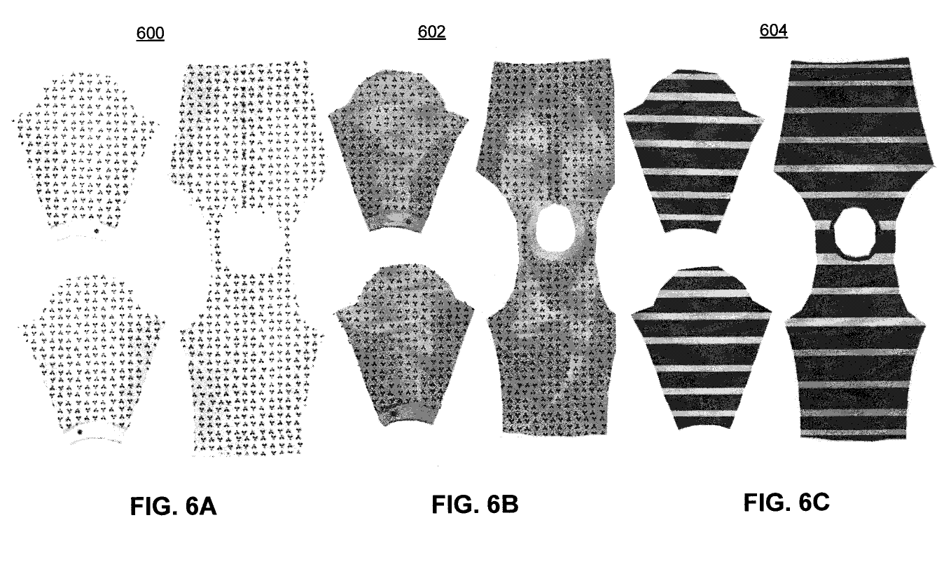

FIG. 5A depicts an example mask layer. Each mask layer defines a fill area to provide a base color for a clothing item worn by an avatar. FIG. 5B depicts an example detail layer defining details for a piece of clothing worn by the avatar. FIG. 5C illustrates an example shadow layer defining shadows to be displayed on a piece of clothing worn by the avatar. FIGS. 6A-6C depict examples of merged results. Multiple layers can be merged together by drawing one layer on top of another layer in a predefined order until all layers have been drawn. Every layer, other than the mask layer, can be transparent, allowing the layer below to show through. In addition, the colors of the different layers can be blended in accordance with a color blending function giving the clothing a more realistic appearance.

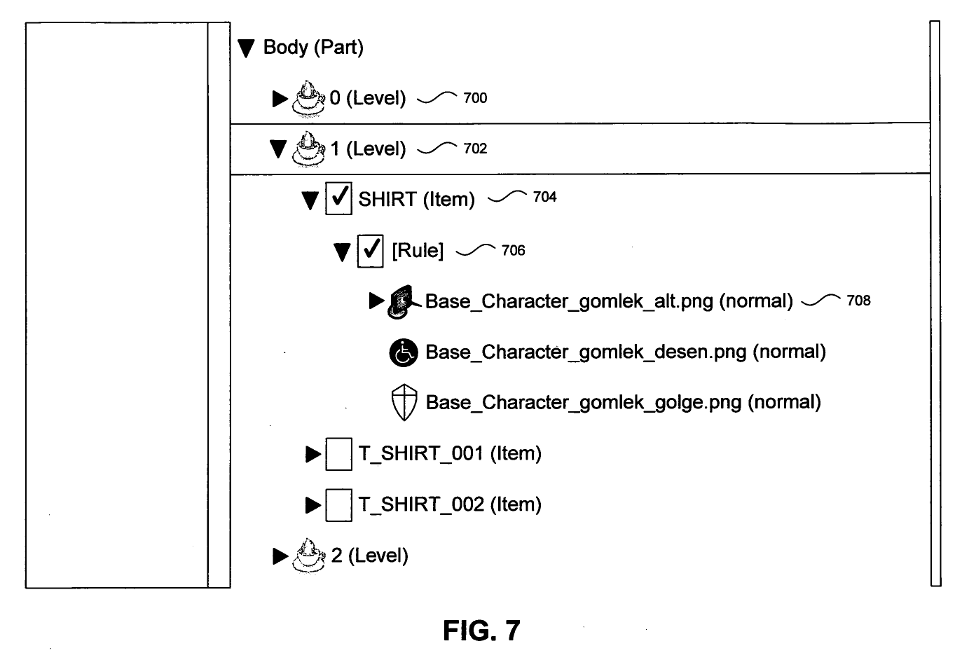

FIG. 7 depicts a hierarchical tree GUI that may be used to select and modify layers associated with 3D objects. In the illustrated embodiment, each 3D object 700 is associated with one or more layers 702. The layers are drawn on the final render in a predefined order. In one example, layer ‘0 ’ contains avatar skin images, layer 1 contains shirts, layer 3 contains coats, etc. Other layer definitions can also be used, such as a mask layer, detail layer, and shadow layer. For example, shirt 704 is defined in level 702. It will be appreciated that multiple items can also be defined within each level. Shirt 704 is associated with one or more rules 706, which define drawing properties, drawing order, and color blending functions. Layer 702 can be associated with an image file 708, which specifies images to use for drawing layer 702.

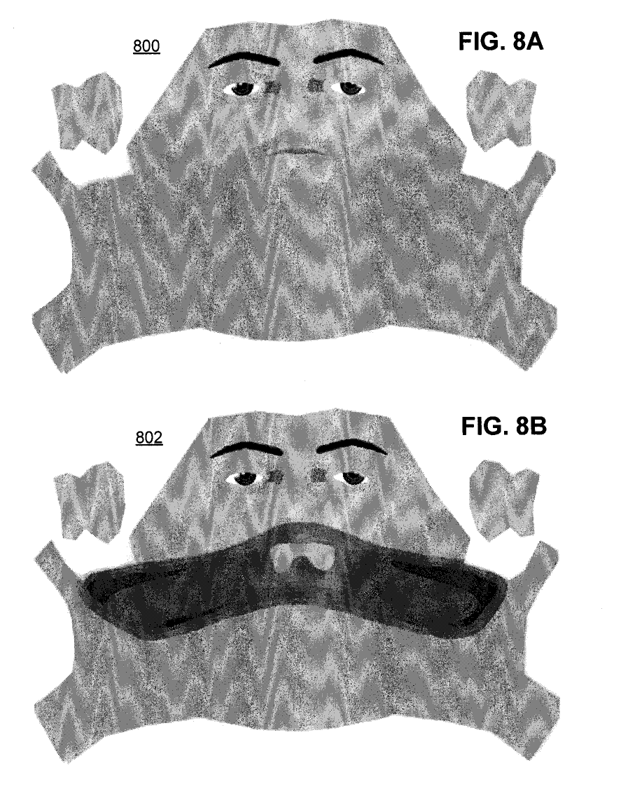

FIG. 8A depicts an example face texture. It will be appreciated that the above processes can also be applied to any 3D object with texture. FIG. 8B depicts an example face texture with beard color. With the addition of the beard layer, the face texture 802 now includes a beard for display on the avatar. Face texture 800 can be defined for use on the avatar using the following layer tree, for example:

Face

Level 0

Skin

RuleSet

Skin Mask
Skin Shadow

Level 1

Eyes

RuleSet

White Detail
Pupil
Lid

Level 2

Mouth

RuleSet

Mouth Detail (multiply)

Level 3

Beard 1

RuleSet

Beard Detail (multiply)

Beard 2

RuleSet

Beard Detail (multiply)

Mustache

RuleSet

Beard Detail (multiply)

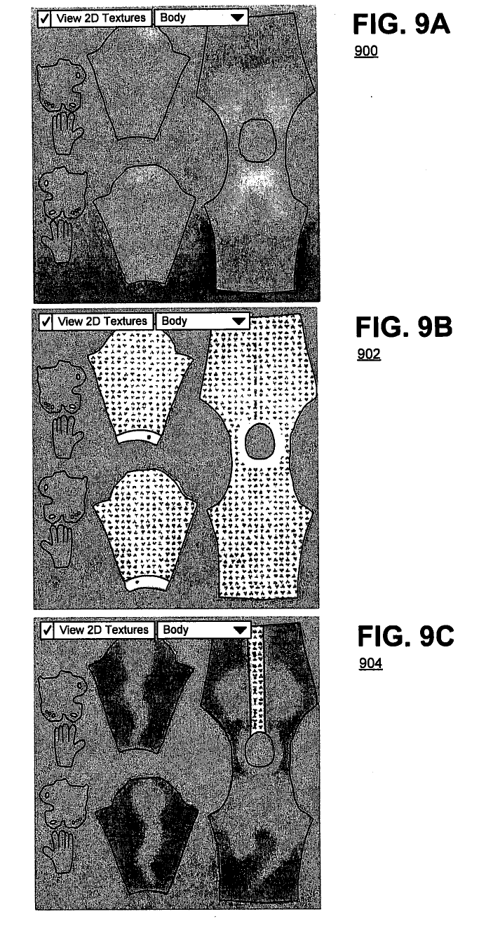

FIGS. 9A-9C depict examples of final texture data. In FIG. 9A, the base layer, detail layer, and shadow lawyer information depict avatar skin images. Final texture data 900 may be created by combining all associated layer information. FIG. 9B depicts final texture data 902 for adding a shirt to the avatar skin images illustrated in FIG. 9A. Similarly, base layer, detail layer, and shadow lawyer information are added to the texture to illustrate a shirt worn by the avatar. FIG. 9C depicts final texture data 904 for adding a jacket to the avatar with the shirt illustrated in FIG. 9B. Similarly, base layer, detail layer, and shadow lawyer information are added to the texture to illustrate a jacket worn by the avatar.

FIG. 10 illustrates an example texture tool. In the illustrated embodiment, GUI 1000 is provided for users to enter commands modifying a layer and its associated characteristic for a 3D object. A “properties menu” 1002 may be provided to allow users to select a mask color, texture color, and skin color: each color can be associated with both color properties and color blend function. A “2D texture checkbox” 1004 may also be provided to allow users to specify viewing textures as 2D images. Alternatively, the user can view the textures as applied to a 3D object, such as an avatar 1006. A “layers menu” 1008 allows the user to specify a body mesh object, a hair mesh object, a leg mesh object, and a face mesh object. The layers menu 1008 also allows the user to initiate a texture editor and to edit various properties of each mesh object. Menu 1010 allows the user to access other functionality of the texture tool including adding a level, a mask, a color pair, an item, a detail, a rule, a shadow, and remove any previously added element.

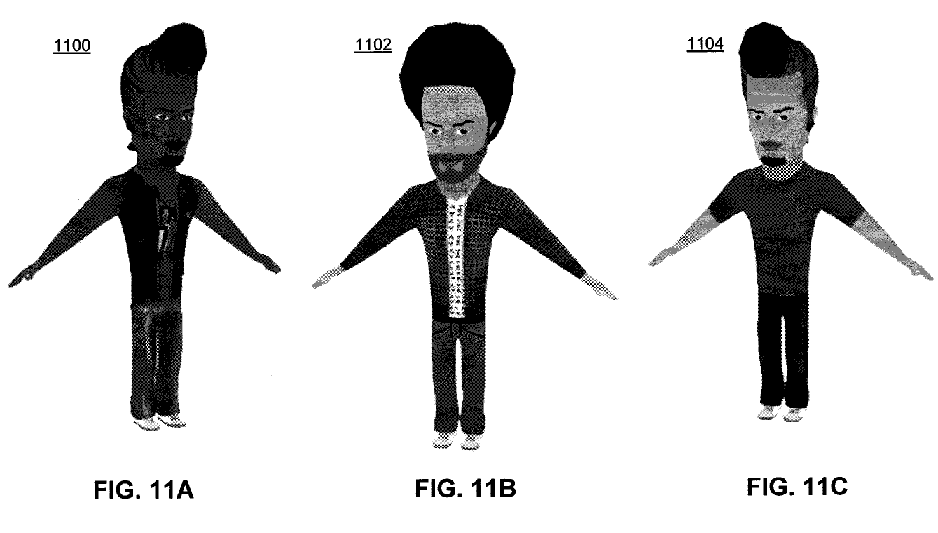

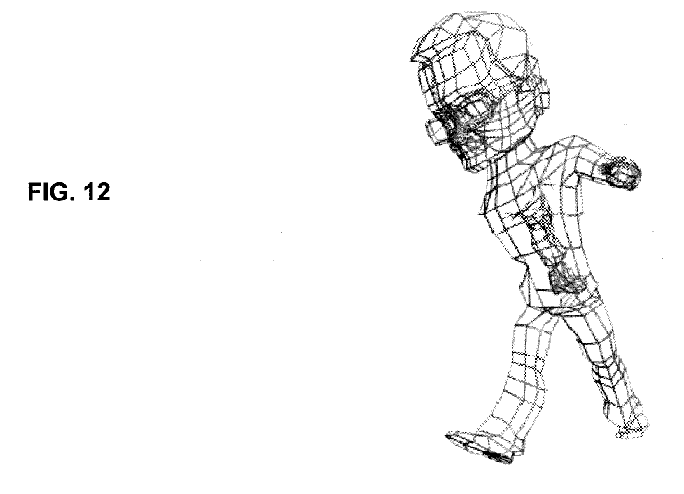

Finally, FIGS. 11A-11C depict examples of avatars with texture added. The avatars are defined by mesh objects, skeletons, and textures as discussed above.

Specific embodiments described herein represent embodiments of the present invention, and are, therefore, illustrative in nature. It will be appreciated by persons of skill in the art that certain embodiments may be practiced without these specific details. In addition, references in the description above to “one embodiment” or “at least certain embodiments,” etc., means that a particular feature, structure, or characteristic described in connection with the embodiment is included in at least one embodiment, but not necessarily all embodiments. Features and aspects of various embodiments may be integrated into other embodiments, and embodiments illustrated in this document may be implemented without all of the features or aspects illustrated or described. It is to be understood that the disclosure need not be limited to the disclosed embodiments; and that all permutations, enhancements, equivalents, combinations, and improvements thereof, that are apparent to those skilled in the art upon a reading of the specification and a study of the drawings, are included within the scope of the invention.

Additionally, it will be apparent from this description that embodiments may be implemented, at least in part, in software, hardware, firmware, or any combination thereof. Therefore, the techniques described herein are not limited to any specific combination of hardware circuitry, software, or firmware; or to any particular source for the instructions executed by a computer system or other data processing system. Rather, these techniques may be carried out in a computer system or other data processing system in response to one or more processors, such as a microprocessor, executing sequences of instructions stored in memory or other computer-readable media including any type of: ROM; RAM; cache; network memory; floppy disk; hard drive disk (HDD); solid-state device (SSD); CD-ROM; optical disk; magnetic-optical disk; EPROM; EEPROM; flash; or any other type of media suitable for storing instructions in electronic format. And the processor may include one or more of: programmable general-purpose or special-purpose microprocessors; digital signal processors (DSPs); programmable controllers; application specific integrated circuits (ASICs); programmable logic devices (PLDs); or the like, or a combination of such devices. In alternative embodiments, special-purpose hardware such as logic circuits or other hardwired circuitry may be used in combination with software or firmware instructions to implement the techniques described herein.

What is claimed is:

1. A method for rendering a three-dimensional (3D) object, comprising:
retrieving a mask layer defining a color for a fill area;
retrieving a detail layer defining 3D object details to be displayed;
retrieving a shadow layer defining 3D object surface shadows; and
merging the mask layer, the detail layer, and the shadow layer into a texture for rendering on the 3D object, wherein each layer includes a plurality of rule sets defining drawing properties of the layer.

2. The method of claim 1, further comprising color blending the layers pursuant to the plurality of rule sets.

3. The method of claim 2, wherein the plurality of rule sets is nested by priority.

4. An article of manufacture comprising:
a computer-readable storage medium having instructions stored thereon, which when executed by a computer, cause the computer to perform a method of rendering a three-dimensional (3D) object, the instructions including:
instructions to retrieve a mask layer defining a color for a fill area;
instructions to retrieve a detail layer defining 3D object details to be displayed;
instructions to retrieve a shadow layer defining 3D object surface shadows; and
instructions to merge the mask layer, the detail layer, and the shadow layer into a texture for rendering on the 3D object, wherein each layer includes a plurality of rule sets defining drawing properties of the layer.

5. The article of manufacture of claim 4, further comprising instructions to color blend the layers pursuant to the plurality of rule sets.

6. The article of manufacture of claim 5, wherein the plurality of rule sets is nested by priority.

7. An article of manufacture comprising:
a computer-readable storage medium having instructions stored thereon, which when executed by a computer, cause the computer to provide a graphical user interface (GUI) configured to manipulate three-dimensional (3D) object textures, the instructions including:
instructions to retrieve a mesh object for editing, wherein the mesh object is associated with a mask layer, a detail layer, and a shadow layer;
instructions to display a hierarchical tree of the layers associated with the mesh object, wherein each layer is associated with a predetermined drawing order, a color blending function, and a rule set;
instructions to add or edit a layer associated with the mesh object responsive to receiving a first set of user commands; and
instructions to add or edit at least one of the predetermined drawing order, the color blending function, and the rule set associated with a layer, responsive to receiving a second set of user commands.

8. The article of manufacture of claim 7, further comprising instructions to automatically render the 3D object for user preview.

9. The article of manufacture of claim 8, further comprising instructions to store the 3D object in an accessible storage medium.

10. The article of manufacture of claim 9, wherein the mesh object is user-specified.

11. An apparatus for rendering a three-dimensional (3D) object, comprising:
a processor;
a memory coupled with the processor over an integrated circuit bus; and
a texture tool component configured to:
retrieve a mask layer defining a color for a fill area;
retrieve a detail layer defining 3D object details to be displayed;
retrieve a shadow layer defining 3D object surface shadows; and
merge the mask layer, the detail layer, and the shadow layer into a texture for rendering on the 3D object, wherein each layer includes a plurality of rule sets defining drawing properties of the layer.

12. The apparatus of claim 11, wherein the texture tool is further configured to color blend the layers pursuant to the plurality of rule sets.

13. The apparatus of claim 12, wherein the plurality of rule sets is nested by priority.

14. The apparatus of claim 11, wherein the texture tool is implemented in software stored in the memory.

15. The apparatus of claim 11, wherein the texture tool is implemented in hardware coupled with the memory.

16. An apparatus configured to provide a graphical user interface (GUI) for manipulating three-dimensional (3D) object textures, comprising:
a processor;
a memory coupled with the processor over an integrated circuit bus; and
a texture tool component configured to:
retrieve a mesh object for editing, wherein the mesh object is associated with a mask layer, a detail layer, and a shadow layer;
display a hierarchical tree of layers associated with the mesh object, wherein each layer is associated with a drawing order, a color blending function, and a rule set;
add or edit a layer associated with the mesh object responsive to receiving a first set of user commands via the GUI; and
add or edit at least one of the drawing order, the color blending function, and the rule set associated with a layer, responsive to receiving a second set of user commands via the GUI.

17. The apparatus of claim 16, further comprising instructions to store the 3D object in an accessible storage medium.

18. The apparatus of claim 17, further comprising instructions to automatically render the 3D object for user preview.

19. The apparatus of claim 16, wherein the mesh object is user-specified.

20. The apparatus of claim 16, wherein the texture tool is implemented in software stored in the memory.

21. The apparatus of claim 16, wherein the texture tool is implemented in hardware coupled with the memory.
